(19) United States
(12) Patent Application Publication
(10) Pub. No.: US 2025/0252564 A1
(43) Pub. Date: Aug. 7, 2025

(54) DETERMINING DEFOCUS IN IMAGE DATA RELATED TO A PREPARED BLOOD SAMPLE

(71) Applicant: Radiometer Medical ApS, Brønshøj (DK)

(72) Inventors: Mohammad Esmail ARYAEE PANAH, Brønshøj (DK); Peter Emil LARSEN, Brønshøj (DK)

(21) Appl. No.: 18/880,878

(22) PCT Filed: Jul. 3, 2023
(86) PCT No.: PCT/EP2023/068153

§ 371 Date: Jan. 3, 2025

(30) Foreign Application Priority Data
Jul. 4, 2022 (EP) 22182762.9

(51) Int. Cl. G06T 7/00; G01N 15/1433; G01N 15/1434

(52) U.S. Cl. CPC G06T 7/0012; G01N 15/1433; G01N 15/1434; G06T 2207/30024; G06T 2207/30168

(57) ABSTRACT

A method is used to determine defocus in image data related to a prepared blood sample, via a blood analyzer. The image data includes data related to at least one imaging plane corresponding to a depth of the prepared blood sample; and is analyzed by identifying an object region that includes a group of pixels which corresponds to an object being physically present in the prepared blood sample. The image data is further analyzed by identifying an optical feature of the object region, the optical feature originating from a difference in refractive index between the object and a medium of the prepared blood sample, and the optical feature acting as an additional artifact in the image data that does not represent an object being physically present in the prepared blood sample. A direction of defocus in the image data is determined, based on an appearance of the identified optical feature.

### FIELD OF THE INVENTION

The present invention relates to a method for determining defocus in image data related to a prepared blood sample.

### BACKGROUND OF THE INVENTION

The analysis of a biological fluid sample, such as a prepared blood sample, may be lengthy and require numerous steps, preparation, resources, and advanced equipment. In the case that the analysis is performed by means of an optical system, such as a microscope, it is required that objects being analysed, such as blood cells, are in focus in order to ensure proper, reliable and fast analysis.

US 2020/0358946 A1 discloses systems and methods for capture a whole slide image of a sample, where a camera is configured to capture a digital image of the sample. The system captures a bright field image of the sample, and captures a digital image of the sample illuminated from a first incident angle at a first wavelength and a second incident angle at a second wavelength. The system can determine whether the sample is defocused based on the transitional shift between a first wavelength channel and a second wavelength channel of the captured digital image.

### DESCRIPTION OF THE INVENTION

It is an object of embodiments of the invention to provide a method which allows easy, fast and reliable determination of defocus in image data related to a prepared blood sample.

The invention provides a method for determining defocus in image data related to a prepared blood sample, by means of a blood analyser comprising an imaging system and a probing volume, the method comprising the steps of:
arranging a prepared blood sample in the probing volume of the blood analyser,
obtaining image data related to the prepared blood sample by means of the imaging system of the blood analyser, the image data comprising data related to at least one imaging plane corresponding to a depth of the prepared blood sample,
analysing the obtained image data, including the steps of:
   identifying an object region in the obtained image data, the object region comprising a group of pixels in the image data which corresponds to an object being physically present in the prepared blood sample,
   identifying an optical feature of the identified object region, the optical feature originating from a difference in refractive index between the object and a medium of the prepared blood sample, and the optical feature acting as an additional artefact in the image data that does not represent an object being physically present in the prepared blood sample, and
determining at least a direction of defocus in the image data, based on an appearance of the identified optical feature.

Thus, the method according to the invention is a method for determining defocus in image data related to a prepared blood sample. In the present context the term ‘determining defocus’ should be interpreted to cover determining whether or not a given part of the image data is in focus, determining which parts of the image data may be considered as being in focus or out of focus, respectively, determining to which extent defocused parts of the image data are out of focus or how far ‘off’ the defocused parts are, determining a direction towards focus for defocused parts of the image data, i.e. whether an imaging plane is in front of or behind a focal plane, and/or any other suitable kind of determination which provides information regarding the focus and defocus of the image data.

In the present context the term ‘prepared blood sample’ should be interpreted to mean a blood sample which has undergone one or more preparation steps in order to ensure that appropriate analysis can be performed on the blood sample. Such preparation steps could, e.g., include dilution, applying chemicals, applying reagents, incubation, stabilisation, etc.

In the present context the term ‘image data’ should be interpreted to mean optical data originating from or related to the prepared blood sample. Accordingly, the image data comprises information regarding the prepared blood sample being analysed.

The method is performed by means of a blood analyser, i.e. by means of an apparatus which is configured to perform analysis of prepared blood samples. The blood analyser comprises an imaging system, i.e. a system which is configured to generate the image data, and a probing volume, i.e. a volume which is configured to receive prepared blood samples to be analysed. The imaging system could, e.g., be or comprise a microscope and/or holographic imaging equipment.

In the method according to the invention, a prepared blood sample is initially arranged in the probing volume of the blood analyser.

Next, image data related to the prepared blood sample is obtained by means of the imaging system of the blood analyser. This may, e.g., include directing a light beam towards the prepared blood sample and detecting light leaving the prepared blood sample as a result thereof, e.g. including light which has been scattered, reflected, deflected, diffracted, etc., by objects in the prepared blood sample. Alternatively or additionally, the obtained image data may include at least one holographic image.

The image data obtained in this manner comprises data related to at least one imaging plane corresponding to a depth of the prepared blood sample, and thereby to a distance from the detector of the imaging system. This will be described in further detail below.

Next, the obtained image data is analysed in the following manner. An object region in the obtained image data is identified. The object region comprises a group of pixels in the image data which corresponds to an object being physically present in the prepared blood sample. Thus, the object is a real, physical entity that is actually contained in, i.e. forms part of, the prepared blood sample to be analysed. Accordingly, the object region represents an image of the object, being physically present in the prepared blood sample, in the image data, and thereby the part of the image data which corresponds to the object region contains information regarding the object. Thus, analysis regarding the object may suitably be performed based on the part of the image data which corresponds to the object region.

Furthermore, an optical feature of the identified object region is identified, the optical feature originating from a difference in refractive index between the object and a medium of the prepared blood sample. The optical feature acts as an additional artefact in the image data. Accordingly, contrary to the object described above, the optical feature does not represent an object being physically present in the prepared blood sample. Instead, the optical feature represents a purely optical phenomenon, originating from optical properties at the boundary between the real, physical object being visible in the image data and the surrounding medium, but is not an image of an actual, physical object.

When light crosses an interface between two media with different refractive indices, refraction occurs in accordance with Snell's law, and this gives rise to optical features which can be observed as optical artefacts in the image data. Thus, when incident light hits an object in the prepared blood sample, and the object has a refractive index which differs from the refractive index of the medium of the prepared blood sample, and thereby the medium in which the object is positioned, it can be expected that recognisable optical features will occur as optical artefacts in the image data at or near the object region. However, as described above, such optical features or artefacts do not represent actual, physical objects being present in the prepared blood sample.

It has been discovered by the inventors of the present invention that information regarding defocus of the image data can be derived from such optical features or artefacts. For instance, the optical feature caused by the refraction may act as an additional or imaginary object or artefact in the image data, and the appearance of this additional artefact in the image data depends on whether or not a given observed imaging plane of the image data coincides with a focus plane of imaging system, and, in the case of defocus, also on whether the focus plane is positioned closer to an objective or a detector of the imaging system or further away. Accordingly, by observing the appearance of the optical feature in the image data, it is possible to retrieve information regarding defocus in the image data.

Accordingly, at least a direction of defocus in the image data is finally determined, based on observations of an appearance of the identified optical feature. Thus, it is at least determined whether or not a given imaging plane of the image data coincides with a focus plane of the imaging system, and if not, whether the focus plane is positioned closer to or farther away from an objective or a detector of the imaging system than the imaging plane.

Thus, according to the invention, at least a direction of defocus in the obtained image data is determined in an easy, fast, reliable and robust manner. Thereby a possible defocus can be taken into account or handled in a fast, reliable and robust manner, thereby allowing for reliable and robust automatic analysis of the prepared blood sample. For instance, the appearance of the optical feature can be derived from image data related to a single imaging plane, and it is therefore possible to determine at least a direction of defocus without requiring image data from several imaging planes, illumination by several wavelengths, etc.

The observed optical features referred to above may, in addition to being related to the difference in refractive indices, also be related to the shape of the object.

The step of obtaining image data related to the prepared blood sample may comprise directing a light beam towards the prepared blood sample with a numerical aperture which is smaller than a numerical aperture of an objective of the imaging system.

According to this embodiment, the light beam which is directed towards the prepared blood sample, i.e. the incident or illuminating light beam, has a numerical aperture which is smaller than that of an objective of the imaging system, and thereby of the detecting part of the imaging system. In the present context the term ‘numerical aperture’ should be interpreted to mean a dimensionless number which characterises the range of angles over which an optical system can emit or accept light.

Thus, according to this embodiment, a cone of the incident light beam, defined by the range of emitted angles of the light source, is smaller than an acceptance cone of the objective of the imaging system.

For instance, the numerical aperture of the light beam may be smaller than 80% of the numerical aperture of the objective of the imaging system, such as between 5% and 50% of the numerical aperture of the objective of the imaging system, such as between 10% and 40% of the numerical aperture of the objective of the imaging system.

By applying a numerical aperture of the light beam which is small as compared to the numerical aperture of the of the objective of the imaging system, it is obtained that the entire light beam can be accommodated within the acceptance angle of the objective of the imaging system. Furthermore, by applying a small numerical aperture of the light beam, the prepared blood sample is illuminated with incident light angles within a small range, and thereby the determination of the direction of defocus becomes very precise and robust.

The step of obtaining image data may comprise obtaining at least one holographic image. In such holographic images it is possible to observe optical features of the kind described above. Thus, according to this embodiment, the subsequent analysis is performed on the obtained at least one holographic image, and at least a direction of defocus is determined from an appearance of an identified optical feature appearing in the holographic image.

The object may be a blood cell, such as a white blood cell, a red blood cell or a platelet. According to this embodiment, the interface which defines the transition from a region with one refractive index to a region with another refractive index may be formed by a membrane of the blood cell.

Blood cells have a shape which causes them to act as an optical lens. Thereby a lens effect is created when incident light hits the blood cell, thereby giving rise to a recognisable optical feature, acting as an additional artefact, in the resulting image data.

For instance, for red blood cells the combination of the refractive index of the cell and the shape of the cell causes the red blood cell to act as a concave lens, defining a focal point behind the cell.

Similarly, for white blood cells the combination of the refractive index of the cell and the shape of the cell causes the white blood cell to act as a convex lens, defining a focal point in front of the cell. This is due to the fact that the shapes of red and white blood cells, respectively, differ from each other, in the sense that red blood cells have a substantially concave shape, while white blood cells have a substantially convex shape.

It is an advantage to use image data related to a blood cell for determining defocus of the image data, because thereby the defocus is determined based on an object which is supposed to be analysed, and which is already present in the prepared blood sample, and therefore it is not required to add separate objects, such as microbeads, or a contrast agent, to the prepared blood sample. Furthermore, it is directly determined whether or not a cell to be analysed is in focus.

As an alternative, the object may be any other suitable kind of object being present in the prepared blood sample, and which it may be desirable to analyse. As another alternative, the object may be an object which is present in the prepared blood sample with the sole purpose of determining the defocus in the image data.

Thus, the optical feature may originate from a lens effect created by the object, e.g. as described above.

The step of identifying an optical feature of the identified object region may comprise identifying a first ring shaped feature and a second ring shaped feature, and the step of determining at least a direction of defocus in the image data may comprise determining relative positions of the first and second ring shaped features.

In the case that the object is of a kind which creates a lens effect, e.g. a blood cell as described above, this may give rise to an optical feature, i.e. an additional artefact, in the image data in the form of two ring shaped objects arranged circumferentially with respect to the object, where one of the ring shaped objects appears as a dark ring and the other ring shaped object appears as a bright ring.

In the case that the object acts as a convex lens, and the observed imaging plane is closer to the objective and the detector than the focal plane, then the bright ring is arranged closer to the object than the dark ring. However, when the observed imaging plane is further away from the objective and the detector than the focal plane, the dark ring is arranged closer to the object than the bright ring. Accordingly, the position of the focal plane is where the dark ring and the bright ring switch position.

Similarly, in the case that the object acts as a concave lens, the positions of the ring shaped features are reversed. Thus, in this case, if the observed imaging plane is closer to the objective and the detector than the focal plane, then the dark ring is arranged closer to the object than the bright ring, and when the observed imaging plane is further away from the objective and the detector than the focal plane, then the bright ring is arranged closer to the object than the dark ring.

Accordingly, the mutual positions of the ring shaped objects reveal whether the observed imaging plane is arranged closer to or further away from the objective and the detector than the focal plane, and thereby the direction of defocus can be derived from this information alone. As described above, this may only require image data related to a single imaging plane.

Furthermore, the ring shaped objects become increasingly ‘blurred’ the further away from the focal plane the observed imaging plane is positioned. Thereby information regarding the size or magnitude of the defocus may also be derived from the appearance of the ring shaped objects.

The step of determining at least a direction of defocus in the image data may further be based on applying knowledge regarding the object. This may, e.g., include applying knowledge regarding the optical properties of the object, such as whether or not the object creates a lens effect, and if so, whether it acts as a concave lens or as a convex lens.

As described above, a red blood cell is expected to act as a concave lens, whereas a white blood cell is expected to act as a convex lens. Thus, if it is known whether the observed object is a red blood cell or a white blood cell, a direction of defocus can readily be derived from an observed order of the dark ring and the bright ring in the image.

The method may further comprise the step of determining a size or magnitude of defocus in the image data. This could, e.g., be performed based on how ‘blurred’ the identified optical feature appears in the image data, as described above.

The image data may comprise a plurality of images, each image being related to an imaging plane, the image data thereby forming a stack of images related to a plurality of imaging planes, and the method may further comprise the step of identifying an imaging plane among the plurality of imaging planes in which an image of the object is in focus.

According to this embodiment, the image data is in the form of a stack of images, each image being obtained at a specific depth of the prepared blood sample, and thereby corresponding to a specific imaging plane. Thereby the stack of images comprises several images of the same object at various depths, and thereby at various distances from the objective and the detector of the imaging system. The images of the object at the various imaging planes may be compared, in particular comparing the appearance of the identified optical feature across the imaging planes. Thereby it can be determined which of the imaging planes are arranged closer to the objective and the detector than the focal plane, and which are arranged further away. Accordingly, the imaging plane which is closest to the focal plane, and thereby the imaging plane being the one where the object may be regarded as being in focus, can be identified.

For instance, in the case that the object is of a kind which creates a lens effect, e.g. a blood cell, and the identified optical feature is of a kind which comprises a first ring shaped feature and a second ring shaped feature, then the imaging plane in which the ring shaped features appear to switch position may be identified as the imaging plane in which an image of the object is in focus.

Subsequently, analysis of the object may be performed based on the part of the image data which represent the object being in focus, i.e. based on the image of the identified imaging plane.

The embodiment described above is well suited for a set-up where the prepared blood sample is substantially stationary, and where it is therefore possible to obtain several images at several depths of the prepared blood sample.

As an alternative, the image data may comprise data from only one imaging plane, and the method may further comprise the step of adjusting at least one setting of the imaging system, based on the determined direction of defocus.

According to this embodiment, image data from only one imaging plane is obtained, and based thereon at least a direction of defocus is determined, in the manner described above, i.e. merely by observing the appearance of the identified optical feature or artefact. For instance, in the case that the object is of a kind which creates a lens effect, e.g. a blood cell, and the identified optical feature is of a kind which comprises a first ring shaped feature and a second ring shaped feature, then the direction of defocus can be immediately determined merely by observing the order of the rings, as described above. Once the direction of defocus has been determined, at least one setting of the imaging system may be adjusted, in order to bring the image of the object into focus. Subsequently, analysis may be performed on the object, based on the focused image.

This embodiment is well suited for a set-up where the prepared blood sample moves, such as a flowing blood sample, and where it is therefore not possible or practical to obtain several images of the same object at various depths of the prepared blood sample.

### BRIEF DESCRIPTION OF THE DRAWINGS

The invention will now be described in further detail with reference to the accompanying drawings in which

FIG. 1 is a diagrammatic view of a blood analyser for performing a method according to an embodiment of the invention,

FIG. 2 illustrates stacks of images relating to a plurality of imaging planes, and obtained at various settings of numerical aperture for the incident light beam, and

FIG. 3 shows simulations of images of a blood cell at various settings of numerical aperture and image depth.

### DETAILED DESCRIPTION OF THE DRAWINGS

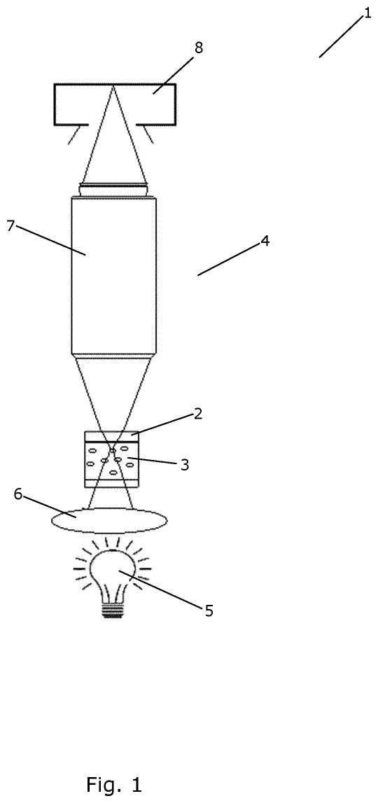

FIG. 1 is a diagrammatic view of a blood analyser 1 for performing a method according to an embodiment of the invention. The blood analyser 1 comprises a probing volume 2 holding a prepared blood sample 3. The blood analyser 1 further comprises an imaging system 4 comprising a light source 5 illuminating the prepared blood sample 3 via a focusing lens 6. Furthermore, the blood analyser 1 comprises an objective 7 collecting light from the prepared blood sample 3 and providing the collected light to a detector 8. It should be noted that, even though only one focusing lens 6 is shown in FIG. 1, it is not ruled out that the imaging system 4 comprises two or more focusing lenses 6.

The blood analyser 1 of FIG. 1 may be operated in the following manner. The prepared blood sample 3 is illuminated by means of the light source 5, and via the focusing lens 6. Accordingly, the light of the light source 5 is focused at a focal plane within the prepared blood sample 3. During this, image data is obtained by means of the imaging system 4, i.e. by means of the objective 7 and the detector 8, and based on light from the prepared blood sample 3. The numerical aperture of the illuminating light beam is smaller than the numerical aperture of the objective 7, thereby ensuring that the illuminating light beam is with the acceptance cone of the objective 7.

The obtained image data may include a plurality of images, each image being related to an imaging plane corresponding to a depth of the prepared blood sample 3. In this case the obtained image data forms a stack of images representing various depths of the prepared blood sample 3. As an alternative, the obtained image data may be related to only one imaging plane, corresponding to only one depth of the prepared blood sample 3.

The obtained image data is then analysed in order to determine at least a direction of defocus in the image data. This may be done in the following manner. An object region is identified in the obtained image data, where the object region comprises a group of pixels in the image data which corresponds to an object, such as a blood cell, in the prepared blood sample 3. Accordingly, an image representation of an object is identified in the image data, the object being a real, physical object which is physically present in the prepared blood sample 3.

An optical feature of the identified object region is then identified, where the optical feature originates from a difference in refractive index between the object and a medium of the prepared blood sample 3. The optical feature may, e.g., be caused by diffraction. The optical feature acts as an additional artefact in the image data, and, contrary to the object, it does not represent a real, physical object being physically present in the prepared blood sample 3.

Finally, at least a direction of defocus in the image data is determined, based on an appearance of the identified optical feature.

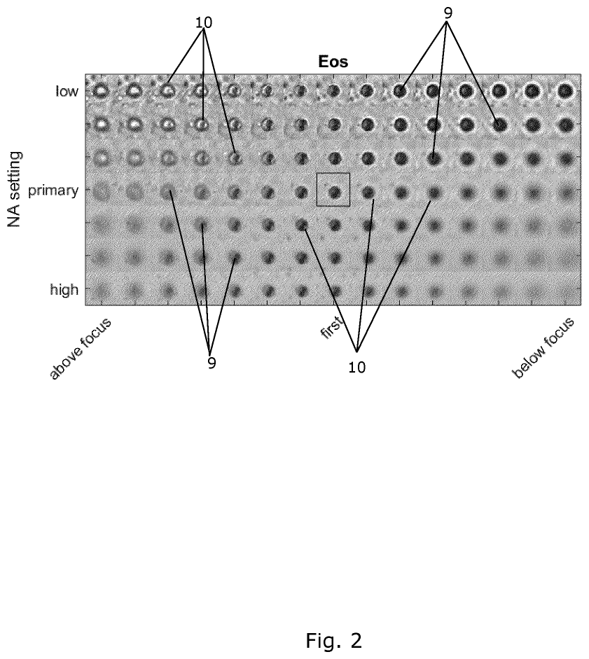

FIG. 2 is an illustration of image data, in the form of a stack of images, obtained as part of an embodiment according to the invention. The image data may, e.g., be obtained by means of the blood analyser of FIG. 1. The images are obtained at 15 different depths of the prepared blood sample, arranged in 15 columns, and with 7 different numerical aperture settings for the illuminating light beam, arranged in 7 rows. Accordingly, each of the 105 images shown in FIG. 2 represents a depth and a numerical aperture, corresponding to the column and row, respectively, where the image is positioned.

Each of the images shows an object region representing an object in the form of a blood cell 9 in the prepared blood sample. Accordingly, the images all show the same cell 9, but obtained at various depths of the prepared blood sample and with various settings with respect to numerical aperture of the illuminating light beam. The numerical aperture of the objective of the imaging system is kept constant.

The blood cell 9 defines a refractive index which differs from the refractive index of the surrounding medium of the prepared blood sample. Furthermore, the shape of the blood cell 9, in combination with the difference in refractive index, introduces a lens effect in the sense that the blood cell 9 acts as a convex lens. This lens effect appears in the image data in the form of a pair of ring-shaped features 10 arranged circumferentially with respect to the blood cell 9. Thus, the pair of ring-shaped features 10 do not represent a real, physical object being physically present in the prepared blood sample, but is rather an additional artefact in the image data, originating from the optical properties at the boundary between the blood cell 9 and the surrounding medium of the prepared blood sample, as described in detail above.

The pair of ring-shaped features 10 includes a first ring which appears dark and a second ring which appears bright. It can be seen that for the depths of the prepared blood sample which are arranged above a focal plane for the system, i.e. which are closer to the objective and the detector than the focal plane, the bright ring is arranged closer to the blood cell 9 than the dark ring. On the contrary, for the depths of the prepared blood sample which are arranged below the focal plane, i.e. which are further away from the objective and the detector than the focal plane, the order of the rings is reversed, i.e. the dark ring is arranged closer to the blood cell 9 than the bright ring. Accordingly, the mutual positions of the pair of ring-shaped features 10 reveals whether a given image is obtained at a depth which is above or below the focal plane of the system. Thus, merely by studying the pair of ring-shaped features 10 a direction of defocus of the image data can be readily derived, and this can be done by studying only one of the 105 images shown in FIG. 2.

It can further be seen that the further away from the focal plane, the more ‘blurred’ the pair of ring-shaped features 10 appear. Thus, it is also possible to derive information regarding the size or magnitude of the defocus from the image data. Finally, the focal plane of the system can be identified as the depth where the dark and the bright rings switch position, corresponding to the image which is marked by a square.

Furthermore, it can be seen that in the images obtained with low numerical aperture of the illuminating light beam, the effect described above is significantly more pronounced than in the images obtained with higher numerical aperture of the illuminating light beam. This is due to the fact that, at low numerical apertures, the range of angles emitted from the light source is small, and therefore the light which reaches the prepared blood sample comprises almost only components which are substantially perpendicular to the prepared blood sample. This causes the lens effect of the blood cell 9 to appear clearly. Accordingly, it is an advantage to apply a low numerical aperture of the illuminating light beam, relative to the numerical aperture of the objective of the imaging system, because this will allow the direction of defocus, and possibly the position of the focal plane, to be determined fast, accurately, reliably and robustly.

Once the direction of defocus has been determined, as described above, a focused image of the blood cell 9 can be obtained fast and easily, e.g. by selecting the image obtained at the focal plane or by adjusting settings of the blood analyser until the blood cell 9 is in focus. Subsequently, automatic analysis of the prepared blood sample, notably on the blood cell 9, can be performed, based on the focused image. Since it is ensured that the image data used for analysis is in focus, the analysis will be reliable and robust.

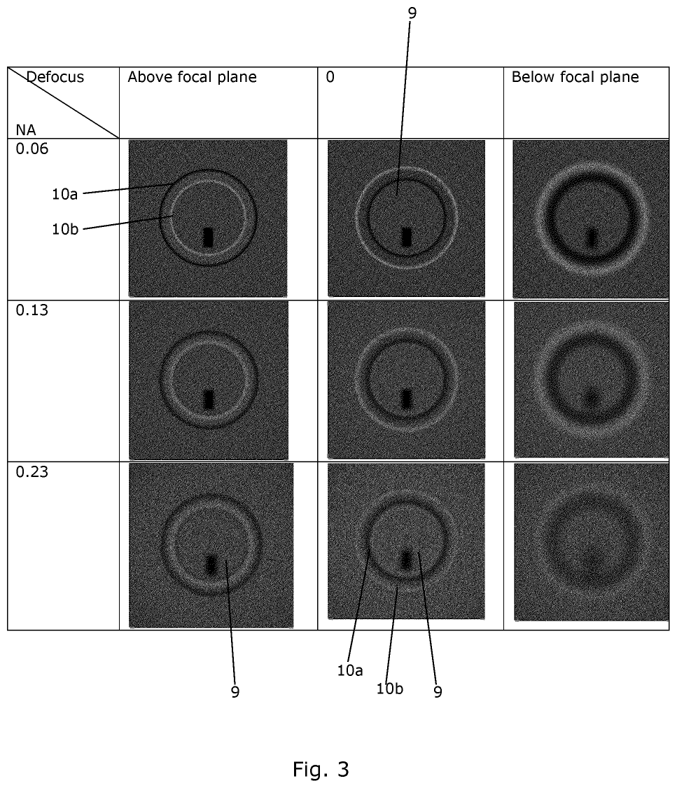

FIG. 3 shows simulations of images of a blood cell 9 at various settings of numerical aperture and image depth, and illustrating the effect described above with reference to FIG. 2. The blood cell 9 is simulated as a hollow convex lens shaped object. In the simulated images, the dark ring 10a and the bright ring 10b can be clearly seen. It can also be seen that the rings 10a, 10b switch position at the focal plane, and that the effect is most pronounced at low numerical apertures.

1. A method for determining defocus in image data related to a prepared blood sample, by means of a blood analyzer comprising an imaging system and a probing volume, the method comprising the steps of:
arranging a prepared blood sample in the probing volume of the blood analyzer;
obtaining image data related to the prepared blood sample by means of the imaging system of the blood analyzer, the image data comprising data related to at least one imaging plane corresponding to a depth of the prepared blood sample; and
analyzing the obtained image data, analyzing the obtained image data including the steps of:
identifying an object region in the obtained image data, the object region comprising a group of pixels in the image data which corresponds to an object being physically present in the prepared blood sample,
identifying an optical feature of the identified object region, the optical feature originating from a difference in refractive index between the object and a medium of the prepared blood sample, and the optical feature acting as an additional artifact in the image data that does not represent an object being physically present in the prepared blood sample, and
determining at least a direction of defocus in the image data, based on an appearance of the identified optical feature.

2. A method according to claim 1, wherein the step of obtaining image data related to the prepared blood sample comprises directing a light beam towards the prepared blood sample with a numerical aperture which is smaller than a numerical aperture of an objective of the imaging system.

3. A method according to claim 2, wherein the numerical aperture of the light beam is smaller than 80% of the numerical aperture of the objective of the imaging system.

4. A method according to claim 3, wherein the numerical aperture of the light beam is between 5% and 50% of the numerical aperture of the objective of the imaging system.

5. A method according to claim 1, wherein the step of obtaining image data comprises obtaining at least one holographic image.

6. A method according to claim 1, wherein the object is a blood cell.

7. A method according to claim 1, wherein the optical feature originates from a lens effect created by the object.

8. A method according to claim 1, wherein the step of identifying an optical feature of the identified object region comprises identifying a first ring shaped feature and a second ring shaped feature, and wherein the step of determining at least a direction of defocus in the image data comprises determining relative positions of the first and second ring shaped features.

9. A method according to claim 1, wherein the step of determining at least a direction of defocus in the image data is further based on applying knowledge regarding optical properties of the object.

10. A method according to claim 1, further comprising the step of determining a magnitude of defocus in the image data.

11. A method according to claim 1, wherein the image data comprises a plurality of images, each image being related to an imaging plane, the image data thereby forming a stack of images related to a plurality of imaging planes, and wherein the method further comprises the step of identifying an imaging plane among the plurality of imaging planes in which an image of the object is in focus.

12. A method according to claim 10, wherein the image data comprises data from only one imaging plane, and wherein the method further comprises the step of adjusting at least one setting of the imaging system, based on the determined direction of defocus.
